(19) United States
(12) Patent Application Publication
(10) Pub. No.: US 2014/0040621 A1
(43) Pub. Date: Feb. 6, 2014

(54) Mobile Electronic Device

(71) Applicant: Martin Klimke, Muenchen (DE)

(72) Inventor: Martin Klimke, Muenchen (DE)

(73) Assignee: INFINEON TECHNOLOGIES AG, Neubiberg (DE)

(21) Appl. No.: 13/566,344

(22) Filed: Aug. 3, 2012

(51) Int. Cl. H04L 9/32

(52) U.S. Cl. 713/171

(57) ABSTRACT

A mobile device includes a controller with a memory storing a key and a communication interface. The key is configured to be used to generate an authentication sequence. The controller is configured to transmit the key via the communication interface upon request. The communication interface can be an NFC interface.

### TECHNICAL FIELD

Embodiments of the present invention relate to a mobile electronic device, in particular a mobile device that is configured to enable another mobile device to have a security function, such as a functionality for unlocking or locking a locked environment.

### BACKGROUND

Modern cars usually include a locking system that can be operated (opened and closed) using a remote control. When the user wishes to open or close the car, he presses a corresponding button on the remote control which then sends a corresponding authentication sequence via a radio channel to a receiver of the lock system. The receiver uses the received authentication sequence to validate the authentication rights of the remote control and causes the car to open or to close. The remote control has a housing in which in some cases also a physical key is integrated. In some car types, the physical key is required to start the car. Furthermore, the physical key can be used to open the car when a battery of the remote control is empty.

Since mobile phones or mobile multimedia devices are becoming more and more powerful, it may be desirable to have the functionality of a car remote control integrated in mobile phones. This avoids the need to carry a remote control additionally to the mobile phone, which many people always have at hand.

An algorithm that generates the authentication sequence for opening and closing a car usually uses sensitive data, such as a key and credentials. In conventional remotely operable lock systems these data are stored in the remote control by the car manufacturer. Credentials and keys could also be stored in a mobile phone. However, in order to meet the security requirements, this would require the services of a trusted entity, such as a Trusted Service Manager, that would have to be provided with the credentials and keys by the car manufacturer in order to transfer these items to the mobile phone. This process, however, is complex and costly. Furthermore, this process has to be repeated each time the owner of the car changes or each time the car owner uses a new mobile device.

There is therefore a need to easily and securely enable a mobile device, such as a mobile phone or a mobile multimedia device to perform a security relevant operation, such as unlocking a locked environment, such as unlocking a car.

### SUMMARY OF THE INVENTION

A first embodiment relates to a mobile device. The mobile device includes a controller including a key. The controller is configured to be used for generating an authentication sequence, and a communication interface. The controller is further configured to transmit the key via the communication interface upon request.

A second embodiment relates to a method. The method includes providing a first mobile device including a controller, the controller including a key and a communication interface, wherein the key is configured to be used for the generation of an authentication sequence. The method further includes providing a programmable second mobile device including a communication interface. The method further includes: requesting the first mobile device to transmit the key or a derivative of the key from the first mobile device to the second mobile device; and, after the request, transmitting the key or a derivative of the key from the first mobile device to the second mobile device via the communication interface of the first mobile device and the communication interface of the second mobile device.

### BRIEF DESCRIPTION OF THE DRAWINGS

Examples will now be explained with reference to the drawings. The drawings serve to illustrate the basic principle, so that only aspects necessary for understanding the basic principle are illustrated. The drawings are not to scale. In the drawings the same reference characters denote like features.

FIG. 1 illustrates a block diagram of a first mobile device including a controller according to a first embodiment;

FIG. 2 illustrates a block diagram of the first mobile device according to a second embodiment;

FIG. 3 illustrates an embodiment of a second mobile device;

FIG. 4 illustrates a method for transmitting key sequence data from the first mobile device to the second mobile device; and

FIG. 5 schematically illustrates a system comprising a first mobile device, a second mobile device and a lock controller.

### DETAILED DESCRIPTION OF ILLUSTRATIVE EMBODIMENTS

In the following detailed description, reference is made to the accompanying drawings, which form a part thereof, and in which is shown by way of illustration specific embodiments in which the invention may be practiced. In this regard, directional terminology, such as “top,” “bottom,” “front,” “back,” “leading,” “trailing,” “under,” “below,” “lower,” “over,” “upper,” etc., is used with reference to the orientation of the figures being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that the features of the various exemplary embodiments described herein may be combined with each other, unless specifically noted otherwise. Further, terms such as “first,” “second,” and the like, are also used to describe various elements, regions, sections, etc. and are also not intended to be limiting. Like terms refer to like elements throughout the description.

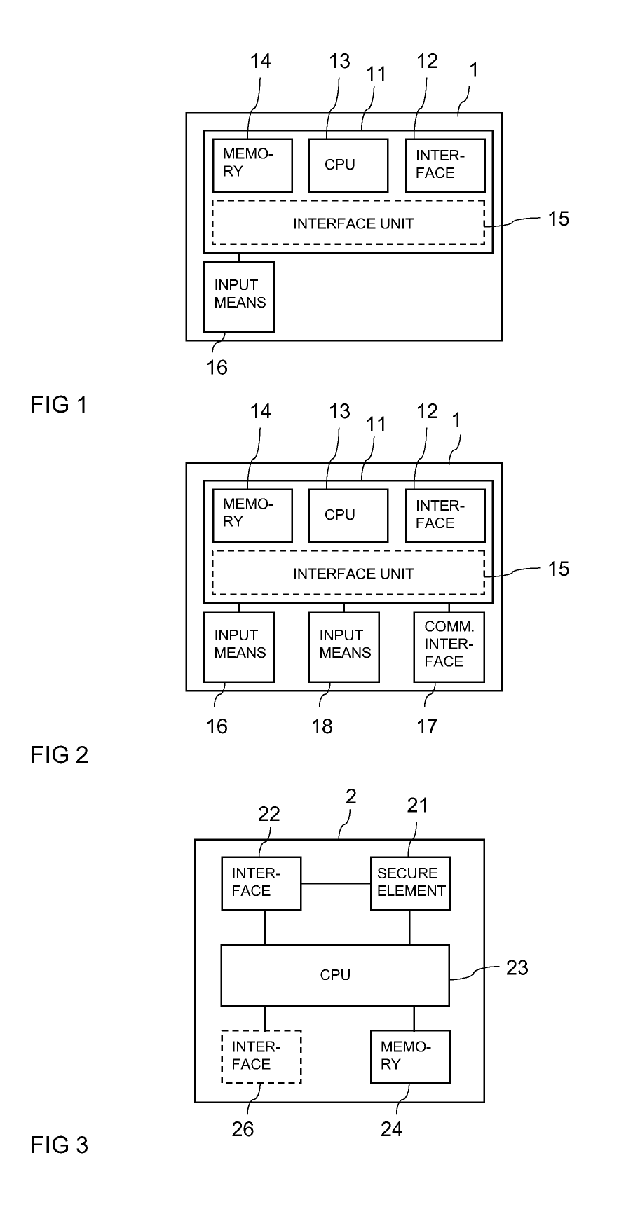

FIG. 1 illustrates a block diagram of an embodiment of a first mobile electronic device 1. The first mobile device includes a controller 11, that can also be referred to as security controller. The controller 11 includes a communication interface 12 that enables the controller 11 to communicate with another mobile device having a corresponding communication interface. Embodiments of such communication are explained in further detail herein below. According to one embodiment, the communication interface is radio interface, specifically an NFC (Near-Field Communication) interface, such as an NFC interface in accordance with ISO standard ISO 14443 or FeliCa.

The controller 11 is configured to include (to have stored therein) a key for generating an authentication sequence. This key can be a conventional key required for generating an authentication sequence for controlling access to a locked environment. The “locked environment” can be a physically or mechanically locked environment, such as a car, a building, an area within a building, a room within a building, such as a hotel room, or can be a virtually locked environment, such as a computer network or any kind of computer terminal, such as a cash terminal, an online banking terminal, a rental car terminal, and the like. To “control access” may include to unlock the environment or to lock the environment.

In a system in which an authentication sequence is used to control access to an environment, there is a receiver configured to receive the authentication sequence, to use the authentication sequence to validate the authentication of the device forwarding the authentication sequence, and to grant access to the locked environment when the authentication process has been successful. The generation of an authentication sequence is based on a shared secret and may include to encrypt a data sequence using the key, where the receiver of the authentication sequence knows the sequence and holds the matching decryption key for decrypting the authentication sequence. The key includes very sensitive data that should be protected from being eavesdropped by unauthorized third parties.

Referring to FIG. 1, the controller 11 further includes a processing unit (CPU) and at least one memory 13. The memory 13 may include two or more sub-memories, such as a program memory for storing program code that can be executed on the CPU, and a data memory for storing the key. Besides the key, an algorithm executed on the CPU is be required for generating an authentication sequence necessary for gaining access to one specific locked environment. The program to execute the algorithm is stored in the controller 11, specifically in the memory 13 of the controller 11. According to one embodiment, the controller is a security controller, that provides a secure tamper-proof environment, so that the key, the credentials and the program running on the controller are securely stored and cannot be read out by non-authorised third parties.

The controller 11 can be implemented as a commercially available security controller such as, e.g., security controllers of the SLE77 family available from Infineon Technologies, Munich. These controllers come with a passive NFC interface and a tamper proof Solid Flash™ data memory, and may include additional interfaces. The specific functionality of controllers of this type can be programmed.

Referring to FIG. 1, the controller 11 may further include an interface unit 15 (illustrated in dashed lines in FIG. 1) and input unit 16 (also illustrated in dashed lines) coupled to the interface unit 15. According to one embodiment, the input unit 16 is a button, a switch, or the like.

Although, referring to the explanation herein before, the key and the program are sensitive data that are to be protected, the first mobile device 1 is configured to transmit upon request the key via the NFC interface 12 to a second mobile device in order to enable the second mobile device to employ the key data. In the following, the “key transmitted via the NFC interface 12” is either the key stored in controller 11 or is a derivative of the key stored in the controller 11.

The key is sent by the controller 11 upon request. The request to send the key is received from a receiver, this request may be generated by a person holding the first mobile device 1 by actuating the optional input unit 16.

The first mobile device includes a housing (not shown) that may correspond to the housing of conventional car remote controls with a maximum size of several centimeters, such as less than 10 cm, less than 8 cm, or even less than 6 cm.

According to one embodiment, the first mobile device 1 is not only configured to transmit the key via the NFC interface 12 upon request, but the controller 11 is also configured to generate an authentication sequence based on the key stored in the controller 11 upon request. This authentication sequence may be used to gain access to a locked environment. In the following, the type of request triggering the transmission of the key via the NFC interface 12 will be referred to as a first type of request, while the type of request triggering generating an authentication sequence in the controller 11 will be referred to as a second type of request. The authentication sequence generated by the controller 11 upon receipt of a second type of request, can be transmitted in different ways explained below.

According to a first embodiment, the authentication sequence is transmitted via the NFC interface 12. The request to generate the authentication sequence in the controller 11 and to transmit the generated authentication sequence via the NFC interface 12 may be received via the NFC interface 12 from a receiver, such as a lock controller in a car, to which the generated authentication sequence is to be transmitted. The authentication sequence can be generated in a conventional way using the key and using an algorithm in the controller 11. According to one embodiment, generating the authentication sequence includes generating a random number, encrypting this number with a key shared by the receiver and the first mobile device, transferring the encrypted number via the NFC interface 12 from the receiver. In the first mobile device the number is decrypted and modified using an algorithm both known at the receiver and the first mobile device. Then the first mobile device encrypts the modified number and transmits the result back to the receiver. The receiver decrypts the received sequence and compares the result with the value he calculated from the random number using the shared algorithm. If the values are matching the receiver knows that the first mobile device knows both the key and the algorithm thus he can consider the first mobile device as authentic. By using a random number the data exchange will always alter from one authentication to the other so consequently no replay attacks are possible.

This method can be simplified by providing counters in the controller 11 and the receiver, wherein these counters are incremented or decremented synchronously each time an authentication sequence is transmitted. Instead of the random number explained before, the counter value is used and encrypted. The receiver will decrypt and compare against the counter value tolerating a certain margin.

According to a further embodiment illustrated in FIG. 2, the first mobile device 1 includes a second communication interface 17 coupled to the interface unit 15 of the controller 11. The interface unit 15 may be configured to couple the controller 11 to several peripheral units in the mobile device 1, such as the optional input unit 16 and the further radio interface 17. The further communication interface 17 is, e.g., a radio interface that is configured to transmit the authentication sequence over a longer distance than the NFC interface 12. According to one embodiment, the second communication interface 17 is a radio interface configured to transmit the authentication sequence using ISM (Industrial, Scientific and Medical) frequency bands.

According to one embodiment, different authentication sequences may be generated dependent on whether the NFC interface 12 or the further interface 17 is used for transmission.

The transmission of the authentication sequence over the second communication interface 17 and the generation of the authentication sequence may correspond to the transmission over the first interface 12 and to the generation of the authentication sequence explained in this connection.

According to another embodiment, the first mobile device 1 includes further input unit 18 also coupled to the controller 11 through the interface unit 15. These second input unit include, e.g., at least one button or switch. In this embodiment, the second type of request (that triggers the generation of the authentication sequence) can be transmitted to the controller 11 by actuating the second input unit 18. In this embodiment, the first mobile device 1 can be operated like a conventional remote control, such as a car remote control. When a user actuates the second input unit 18, the controller 11 based on the key stored in the controller 11 generates an authentication sequence. This authentication sequence is transmitted via the second radio interface 17. When this authentication sequence is considered valid by a receiver, such as a lock controller in a car, access is granted.

While in the first embodiment, in which the authentication sequence is transmitted via the NFC interface 12, the first mobile device 1 has to be in the vicinity of the receiver in order to have the first mobile device 1 communicate with the receiver, a communication over a longer distance, such as several meters, is possible in the second embodiment.

According to one embodiment, the mobile device 1 is configured to transmit the authentication sequence via the NFC interface 12, or to transmit the authentication sequence via the second radio interface 17. For example, the mobile device 1 is a mobile device configured to be used in connection with a car. In this case, the authentication sequence may be transmitted via the second radio interface 17 in order to unlock the car, which means in order to gain access to the car, while the authentication sequence may be transmitted via the NFC interface 12 in order to deactivate an immobilizer of the car, the latter being necessary in order to start the car. In this embodiment, the car can be unlocked when the holder of the mobile device 1 is already several meters away from the car, while the car can only be started when the holder of the mobile device 1 brings the mobile device in close vicinity of an NFC receiver implemented in the car.

Of course, the mechanisms for unlocking a locked environment described above can also be used to lock an environment such as a car, a building, or the like.

Referring to the explanation before, the capability of the mobile device 1 to transmit the key upon request, can be used to enable a second mobile device 2 to generate an authentication sequence in accordance with the key and shared algorithm. A simplified block diagram of a second mobile device 2 that can be enabled in that way is schematically illustrated in FIG. 3.

Referring to FIG. 3, the second mobile device 2 includes a secure element 21, which can be a security controller including a tamper-proof storage for storing sensitive data, such as the key and the algorithm to create the authentication sequence. The second mobile device 2 further includes an NFC interface 22. According to one embodiment, this NFC interface 22 of the second mobile device 2 is an active interface, while the NFC interface 12 of the first mobile device 1 is a passive interface. A passive interface 12 does not have a power supply and receives its power supply over the air from an active interface having an own power supply.

Referring to FIG. 3, the second mobile device 2 further includes a processing unit (CPU) 23, and a memory 24 for storing programs that can be executed in the processing unit 23, and for storing application data. The interface 22 can be operated directly by the secure element 21 without interaction with the CPU 23. The interface 22 can also be configured to be operated in passive mode.

Optionally, the second mobile device 2 additionally to the NFC interface 22 includes a second communication interface 26 such as, e.g., a radio interface for communication in ISM bands. According to one embodiment, the radio interface is implemented as a Bluetooth interface or as a WLAN interface.

The second mobile device 2 may be a mobile phone, in particular a smartphone, or any other type of mobile multimedia device. The second mobile device 2 may be programmed to receive the key from the first mobile device 1 via the NFC interface 22 and to store the key in the secure element 21. The second mobile device 2 may further be programmed to use the key stored in the secure element 21 to generate an authentication sequence and to transmit the authentication sequence either via the NFC interface 22 or via the optional further communication interface 26, so that the second mobile device 2 instead of or additionally to the first mobile device 1 can be used to lock or unlock a secured environment, such as a car, a building, a computer network, or a terminal, etc.

If the second mobile device 2 is using the NFC interface 22 for this communication, this interface may be configured to operate in passive mode. The second mobile device 2 can be programmed by storing a suitable program (mobile application, app) in the memory 24.

Referring to the explanation before, the key transmitted from the first mobile device 1 (that is then stored in the second mobile device 2) is either the key stored in the controller 11 of the first mobile device 1 or is a derivative of the key. The derivate of the key can be generated such that it is specially assigned to the second mobile device. Optionally an expiration date can be assigned to the key and the authentication algorithms can be enhanced in such a way that the expiration date is also transferred to the receiver which can then compare the expiration date with its own system time.

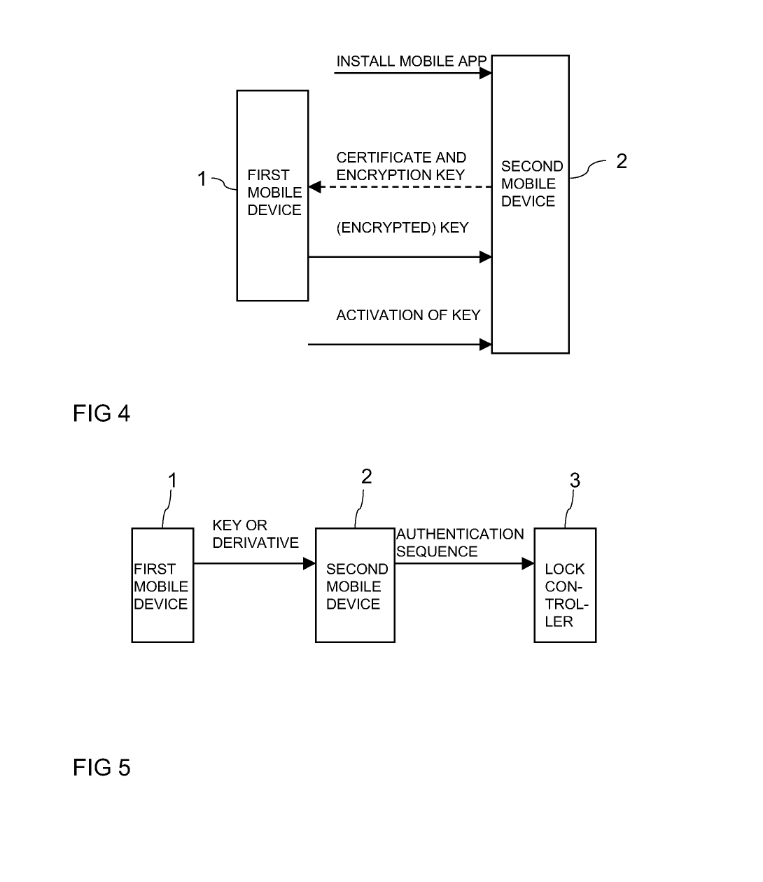

FIG. 4 schematically illustrates method steps of a method for transferring the key from the first mobile device 1 to the second mobile device 2. In FIG. 4, the first and second mobile devices 1 and 2 are only schematically illustrated as function blocks. Emphasis of the illustration in FIG. 4 lies on the illustration of the communication between the first and second mobile devices 1, 2. The first mobile device 1 is already configured by the manufacturer to communicate with a second mobile device 2 to transmit the key to the second mobile device 2 upon request. Referring to the explanation before, the second mobile device 2 can be a conventional mobile phone or mobile multimedia device. In order to enable the second mobile device 2 to communicate with the first mobile device 1, the first mobile device 2 needs to be programmed. For this, a suitable mobile application (app) can be installed (stored) in the second mobile device 2. This mobile application may be downloaded in a conventional way, e.g., from the website of the manufacturer (distributor) of the first mobile device 1. When, e.g., the first mobile device 1 includes a key for generating an authentication sequence to lock/unlock a car, the first mobile device 1 is delivered with the car, and the mobile application may, e.g., be obtained from a mobile application store (App Store).

Having installed the mobile application, the second mobile device 2 is configured to receive the key and to store the key in the secure element (21 in FIG. 3). Thus, the method further includes requesting the first mobile device 1 to transmit the key via the NFC interface 12, so that the first mobile device 1 transmits the key to the second mobile device 2 via the NFC interface 12 in the first mobile device 1 and the NFC interface 22 in the second mobile device 2. Referring to the explanation before, the request to the first mobile device 1 to transmit the key may be sent from the second mobile device 2. This request can be initiated in different ways.

The secure element in the second mobile device 2 explained above is a security controller that can store and execute programs. One program is the algorithm to generate the authentication sequence. The other program is an algorithm to receive the key from the first mobile 1. Additionally the secure element 21 has a certificate store for storing a certificate. This certificate is used to validate the authenticity of the second mobile device 2. It is assumed that both, programs and the certificate, are installed by the manufacturer of the second mobile device 2 and it also assumed that the manufacturer is supporting means to validate the certificate by a CA (certification authority). A certificate is a data structure which is signed and which also contains the public key of the secure element of the second device 2.

Referring to the explanation before, the NFC interface 12 of the first mobile device 1 is a passive interface that is powered through the RF field emitted by the NFC interface of the second mobile device 2. The power received through the NFC interface 12 of the first mobile device 1 also powers the controller 11 in the first mobile device 1. Once the NFC interface 12 of the first mobile device 1 is powered, a secure communication channel is set up between the first mobile device 1 and the second mobile device 2, where the key from the first mobile device 1 will finally be transmitted from the first mobile device 1 to the second mobile device 2 via this secure channel. Setting up a secure communication channel may employ asymmetric cryptographic methods and the verification of certificates.

One embodiment of a method for setting up a secure communication channel between the first mobile device 1 and the second mobile device 2 is explained below. In this embodiment, the second mobile device 2 has a key pair with a public key and a corresponding secret key stored in the secure element. The first mobile device 1, besides the key that can be used for generating an authentication sequence, has a key pair with a public key and a corresponding secret key stored in the controller 11. Once the controller 11 of the first mobile device 1 has been powered, the second mobile device 2 sends its certificate including the public key to the first mobile device 1. The first mobile device 1 verifies the validity of the certificate using a certificate stored in the controller 11. When the certificate is valid it extracts the public key of the second mobile device 2 from the certificate and uses this public key and its own private key to encrypt data which may be the key, the derived key and other data like the previously mentioned expiration date, and transmits the encrypted data to the second mobile device 2. The second mobile device 2 then uses its private key to decrypt the data.

Optionally, the first mobile device 1 creates a random number and transfer this random number encrypted with the received public key and its own private key to the second mobile device 2 to further use this number as a key for symmetric encryption for the communication between the first and second mobile devices 1, 2. The second mobile device 2 decrypts the random number using its private key. In this method, the first mobile device 1 uses then this random number to encrypt data which may be the key, the derived key and other data like the previously mentioned expiration date, and transmits the encrypted data to the second mobile device 2 that is capable of decrypting the data using the same random number.

Optionally the secure element in the second mobile device 2 may also ask for a certificate stored on the first mobile device 1 and may verify the validity of this certificate by having an own certificate store. Referring to the explanation above, the certificates stored in the certificate store of the first mobile device 1 are needed to verify the validity of a certificate received from the second mobile device 2. According to one embodiment, the first mobile device 1 is configured to update the certificates stored in its secure element via the NFC interface 12. The update information may be provided through a mobile phone, such as the second mobile device 2, or through an update station provided by the manufacturer of the first mobile device 1. In case the first mobile device 1 is provided by a car manufacturer, update stations may be available at service centers of the car manufacturer.

According to one embodiment, requesting the first mobile device 1 to transmit the key to the second mobile device 2 includes forwarding an identification phrase from the second mobile device 2 to the first mobile device 1. The identification phrase is to be entered into the second mobile device 2 by a user of the second mobile device 2 and is then transmitted to the first mobile device 1 via the secure channel. The identification phrase can be a PIN (Personal Identification Number that is entered using a program running on the second mobile device 2). The identification pin is given to the authorized holder of the first mobile device 1 together with the first mobile device 1. The identification phrase can be protected in a conventional manner, using an envelope or the like, in order to make sure that only the authorized holder of the first mobile device 1 gains knowledge of the identification phrase, so that only the authorized holder of the first mobile device 1 is in the position to finally enable the second mobile device 2 to generate authentication sequences using the key stored in the first mobile device 1.

The identification phrase has also been stored in the first mobile device by the manufacturer, so that the first mobile device 1 having received the identification phrase over the secure channel checks the validity of the received identification phrase using the stored identification phrase. When the received identification phrase is valid, the first mobile device transmits the key and other data over the secure channel to the second mobile device 2 where it is stored in the secure element 21.

According to a further embodiment, the identification phrase is not entered into the second mobile device 2, but is entered into the first mobile device 1. For this, the first mobile device includes input means for entering the identification phrase. According to one embodiment, the identification phrase is a binary sequence including first and second symbols (such as logical zeros and ones), and the first mobile device includes two buttons for entering the binary sequence, one button for entering the first symbols and one button for entering the second symbols.

The first mobile device 1 may be configured to count the number of transmission events (the number of transmissions of the key from the first mobile device 1 to the second mobile device 2) and to limit the number of transmissions to a predefined number, such as, e.g., a number between 1 and 5. In this embodiment only a predefined number of second mobile device 2 can be enabled. When the maximum number of transmissions has been reached, the first mobile device 1 refuses to transmit the key to the second mobile device 2.

The method explained before, easily allows a user to enable a second mobile device (e.g., a smartphone or a mobile multimedia device) to have the functionality to generate an authentication sequence in accordance with a key. Referring to explanation before, such authentication sequence can be used to authorize a user to lock or unlock an environment. However, the authentication sequence may also be used for other purposes. For example, in a car the authentication sequence can be used to allow the authorized user to retrieve car parameters, such as consumption parameters, the driven distance, etc., from a car controller and to store these parameters on the second mobile device. The authentication sequence may also be used to access an entertainment system in the car, e.g., in order to personalize the system. In each case, the authentication sequence identifies the holder of the second mobile device to be authorized to access the system. The car controller or the entertainment system within a car can also be considered as (virtually) locked environments in the sense of the present disclosure.

FIG. 5 schematically illustrates a system with a first mobile device 1, a second mobile device 2 and a controller 3 of a locked environment. Referring to the explanation above, the first mobile device is configured to transmit a key or a derivative of a key to the second mobile device 2, and the second mobile device 2 is configured to generate an authentication sequence using the key or the derivative. The controller 3 controls access to a locked environment and will be referred to as lock controller in the following.

When, e.g., the environment to be locked or unlocked is a car, the first mobile device 1 is a mobile device that is delivered with the car from the car manufacturer to the authorized holder of the car. The key stored in a specific mobile device 1 is then programmed by the car manufacturer such that the key is suitable to generate an authentication sequence which in turn is suitable to operate a specific car, namely the car delivered with the first mobile device 1. Programming the key into the first mobile device 1 is similar to processes already employed in car manufacturing sites in order to program conventional car remote controls. Thus, no significant changes are required in the manufacturing sites.

Once the second mobile device 2 has been enabled to generate authentication sequences based on the key, only the second mobile device 2 needs to be used to control access to a secured environment. Dependent on the specific implementation of the second mobile device 2, the second mobile device 2 can be used in different ways. Some exemplary operation scenarios are explained below. For explanation purposes it is assumed, that the second mobile device 2 is employed in an automotive environment, which means is employed to lock/unlock a car and/or to mobilize the car.

When the second mobile device 2 is implemented with the further communication radio interface 26, the second mobile device 2 can be used like a conventional car remote control. The second mobile device 2 can be programmed to generate an authentication sequence and to transmit the authentication sequence via the communication interface 25 upon request, such as upon actuating a specified button on the second mobile device 2, to the lock controller. The second mobile device 2 could also be programmed to automatically establish a communication with the lock controller 3 implemented in the car and to transmit the authentication sequence via the communication interface to the lock controller 3 upon request of the lock controller 3. In this case, the car can be unlocked automatically (keyless) when approaching the car.

The mobile device 2 could also be programmed to transmit the authentication sequence via the NFC interface 22. In this embodiment, the mobile device 2 has to be brought in close vicinity of a lock controller of the car having a corresponding NFC interface integrated in the car. The NFC interface 22 in the second mobile device 2 may be implemented as an interface that acts either active (when the first mobile device 1 transmits the key) or that acts passive and receives its power supply from another NFC interface, such as an NFC interface in the car. In this embodiment, the car can even be opened when the battery of the mobile device 2 is empty. The mobile device 2 is then powered through the NFC interface of the lock controller.

The second mobile device 2 can also be used to mobilize/start the car. For this, the second mobile device 2 is brought in close vicinity of an NFC interface in the car and is configured to transmit the key sequence via the NFC interface 22 upon request of a corresponding controller in the car.

The car can also be locked using the second mobile device 2. For this, the second mobile device 2 can be programmed to send a corresponding authentication sequence to the lock controller 3 of the car when a user actuates a specific button by means of a program on the second mobile device 2.

There may be scenarios where it is necessary to revoke the key stored in the second mobile device, e.g., when the car is sold or when the second mobile device 2 is no longer used by the authorized holder of the car. The key stored in the mobile phone may be revoked using the mobile application stored in the second mobile device. According to one embodiment, revocation of the key stored in the second mobile phone requires entering the identification phrase, where the second mobile device 2 revokes the key when the identification phrase is valid. For checking the validity of the entered identification phrase, the identification phrase may be stored in the secure element 21 of the second mobile device at the time when the key is transferred from the first mobile device 1 to the second mobile device. According to a further embodiment, the identification sequence is only stored in the first mobile device. In this case, a secure channel is established between the first and the second mobile devices and the second mobile device requests the first mobile device to check the validity of the entered identification phrase.

According to one embodiment, controllers in the car that control access to the car or to devices (such as the entertainment system) in the car, are configured to register a second mobile device 2 used to access the car. For this, a differentiation between different second mobile devices 2 is required.

According to one embodiment, the first mobile device 1 does not transmit the key stored in the controller 1 to the second mobile device 2, but transmits a derivative (derived key) individually assigned to the second mobile device 2. An authentication sequence generated using such derivative includes an information which derivative has been used to generate the authentication sequence, so that based on the authentication sequence a differentiation between individual second mobile devices is possible. In order to enable the car controllers to differentiate between different second mobile devices 2, the first mobile devices 1 stores information on different derivatives that have been generated and is used to teach the lock controller (is used to register the individual second mobile devices in the car controllers).

Usually the second mobile device 2 and/or the NFC interface 21 has a unique identifier (ID) that can be read out. According to one embodiment, in the process in which the key is transmitted to the second mobile device, the first mobile device 1 receives the ID of the second mobile stores the ID. This ID can be used to register the second mobile device 2 in the car controllers. In this embodiment, the second mobile device 2 is further configured to transmit its ID in or with the authentication sequence so as to allow the car controllers to differentiate between different second mobile devices 2.

When access to one specific second mobile device 2 is not possible, e.g., when the second mobile device 2 has been lost, has been stolen, or has been damaged, so that it is not possible to revoke the derivate stored in the second mobile device 2, the car controllers can be programmed to ignore authentication sequences generated by one specific second mobile device that has been registered before or by means of the car entertainment system which has the ability to delete keys of the car controller.

According to one embodiment, a second mobile device 2 to which a key has been transferred is not registered in the car controllers by the first mobile device, but is registered automatically when the second mobile device is used for the first time to access the car.

When, e.g., the first mobile device 1 has been lost, the authorized owner of the car may retrieve a replacement mobile device 1 from the car manufacturer. The replacement device may then be used to identify the authorized user who may then program the car controllers such that authentication codes generated using the key stored in the lost mobile device (that has been registered by the car controllers during earlier use) are ignored.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A mobile device comprising:
a controller comprising a memory storing a key and a communication interface, the key configured to be used for generating an authentication sequence;
wherein the controller is configured to transmit the key via the communication interface upon request.

2. The mobile device of claim 1, wherein the communication interface is an NFC interface.

3. The mobile device of claim 1, wherein the controller is configured to receive the request for transmitting the key via the communication interface.

4. The mobile device of claim 1, wherein the controller is further configured, upon request, to generate an authentication sequence based on the key, and to transmit the authentication sequence via the communication interface.

5. The mobile device of claim 4, wherein the controller is configured to generate the authentication sequence by encrypting a data sequence using the key to obtain the authentication sequence.

6. The mobile device of claim 4, wherein the request is a request received via the communication interface.

7. The mobile device of claim 4, further comprising an input unit configured to be manually operated and configured to request the mobile device to generate and transmit the authentication sequence.

8. The mobile device of claim 1, further comprising:
a further communication interface coupled to the controller;
wherein the controller is configured upon request to generate an authentication sequence based on the key, and to transmit the authentication sequence via the further communication interface.

9. The mobile device of claim 8, wherein the further communication interface is a radio interface.

10. The mobile device of claim 8, further comprising an input unit configured to be manually operated and configured to request the controller to generate the authentication sequence.

11. The mobile device of claim 1, further comprising a housing having a maximum size of less than 10 cm.

12. The mobile device of claim 1, wherein the mobile device is configured to register each transmission of the key and is configured to refuse the transmission when a predefined number of transmissions have been reached.

13. A method comprising:
providing a first mobile device comprising a controller, the controller comprising a memory storing a key and a communication interface, wherein the key is configured to be used for to generate an authentication sequence;
requesting the first mobile device to transmit the key or a derivative of the key from the first mobile device to a programmable second mobile device that comprises a communication interface; and
in response to the requesting, transmitting the key or the derivative of the key from the first mobile device to the second mobile device via the communication interface of the first mobile device and the communication interface of the second mobile device.

14. The method of claim 13, further comprising:
setting up a secure communication channel between the communication interface of the first mobile device and the communication interface of the second mobile device; and
transmitting the key over the secure communication channel.

15. The method of claim 14, wherein setting up the secure communication channel comprises using asymmetric cryptography.

16. The method of claim 14, wherein the communication interface of the first mobile device and the communication interface of the second mobile device are both NFC interfaces.

17. The method of claim 14, wherein requesting the first mobile device comprises transmitting an identification phrase over the secure channel to the first mobile device.

18. The method of claim 17, further comprising the first mobile device checking whether or not the identification phrase is valid and transmitting the key when the identification phrase is valid.

19. The method of claim 17, further comprising requesting a user to enter the identification phrase.

20. The method of claim 14, further comprising installing a dedicated software application on the second mobile device before requesting the first mobile device to transmit the key or the derivative of the key.

21. The method of claim 14, wherein the first mobile device is configured to register each transmission of the key or the derivative of the key and is configured to refuse transmission when a predefined number of transmissions has been reached.

22. The method of claim 13, further comprising revoking the key or the derivative of the key in the second mobile device.

23. The method of claim 22, wherein revoking the key or the derivative of the key comprises entering an identification number in the second mobile device.

24. The method of claim 22, wherein revoking the key or the derivative of the key comprises:
entering an identification number in the first mobile device; and
transmitting the identification number to the second mobile device through a secure channel.

25. The method of claim 13, further comprising causing the second mobile device to transmit an authentication sequence to a lock controller, the second mobile generating the authentication sequence using the key or the derivative of the key.

26. The method of claim 25,
wherein the second mobile device is associated with a unique identifier, and
wherein the second mobile device transmits the identifier together with the authentication sequence.

27. The method of claim 25, wherein the lock controller is configured to register second mobile devices, and is configured to only accept authentication sequences from registered second mobile devices.
